(19) United States
(12) Patent Application Publication
(10) Pub. No.: US 2004/0046075 A1
(43) Pub. Date: Mar. 11, 2004

(54) Industrial blades with multi-point center and multi-wings

(75) Inventor: Ilhan Gursel, Istanbul (TR)

Correspondence Address: John S. Egbert, Harrison & Egbert, 7th Floor, 412 Main Street, Houston, TX, 77002, US

(73) Assignee: ERNA-MAS MAKINA TICARET VE SANAYI ANONIM SIRKETI, Istanbul (TR)

(21) Appl. No.: 10/251,679

(22) Filed: Sep. 23, 2002

(30) Foreign Application Priority Data
Sep. 9, 2002 (TR) U 2002 02145

(51) Int. Cl. A47J 43/07

(52) U.S. Cl. 241/292.1

(57) ABSTRACT

This invention is related to industrial blades with a multi-point center and multi-wings which can be used with any driven, electric-powered, cutter-parting, stirrer blender, robot and mixer etc. devices either house type or industrial type, positioned at every possible angle with respect to each other and locked to middle axis. With present invention wherein a blade with multi-centers and multi-wings (4, 6) is used instead of a blade with single center and two wings, the time of function is decreased by half as compared to the use of single blade, cut pieces of various foodstuff have identical sizes, ice dices are uniformly broken down into snow sprinkles in a very short period of time (6 seconds) if engine power is sufficient for this purpose and some of the non-stiff foodstuff are fragmented without becoming juicy.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

This invention is related to industrial blades with a multi-point center and multi-wings which can be used with any driven, electric-powered, cutter-parting, stirrer blender, robot and mixer etc. devices either house type or industrial type, positioned at every possible angle with respect to each other and locked to a middle axis.

### BACKGROUND OF THE INVENTION

All currently known electric kitchen robots or blades also acting as a breaker are composed of cutter blades with two wings and a single-point center, and also in blenders there are cutter blades with a single-point center and two or four wings.

### BRIEF SUMMARY OF THE INVENTION

With the present invention, wherein a blade with multi-centers and multi-wings (4, 6) is used instead of a blade with a single center and two wings, the time of function is decreased by half as compared to the use of single blade. Cut pieces of various foodstuff have identical sizes, and ice cubes are uniformly broken down into snow sprinkles in a very short period of time (6 seconds) if engine power is sufficient for this purpose and some of the non-stiff foodstuff are fragmented without becoming juicy.

### BRIEF DESCRIPTION OF THE SEVERAL VIEWS OF THE DRAWINGS

FIG. 1 Use of blades in devices with a side engine block

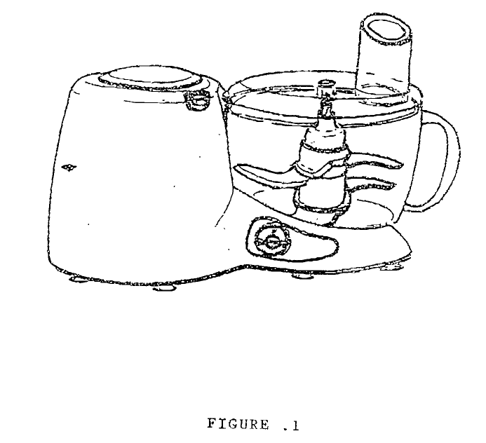

FIG. 2: Position and assembly of blade and other device components in devices with a side engine block (a, b, c, d, e)

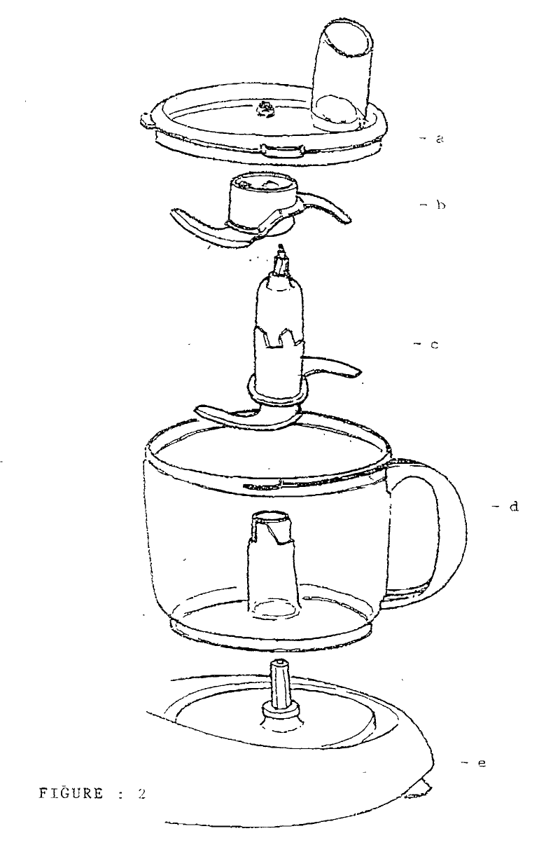

FIG. 3: Blades used in devices with various diameters (a) (b).

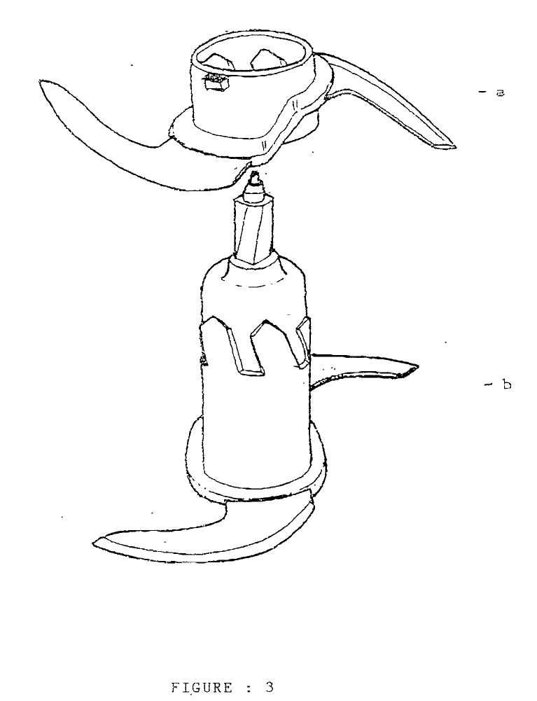

FIG. 4: Side view (a) and top view (b) of the positions of blades with multi-centers and multi-wings at various angles relative to each other.

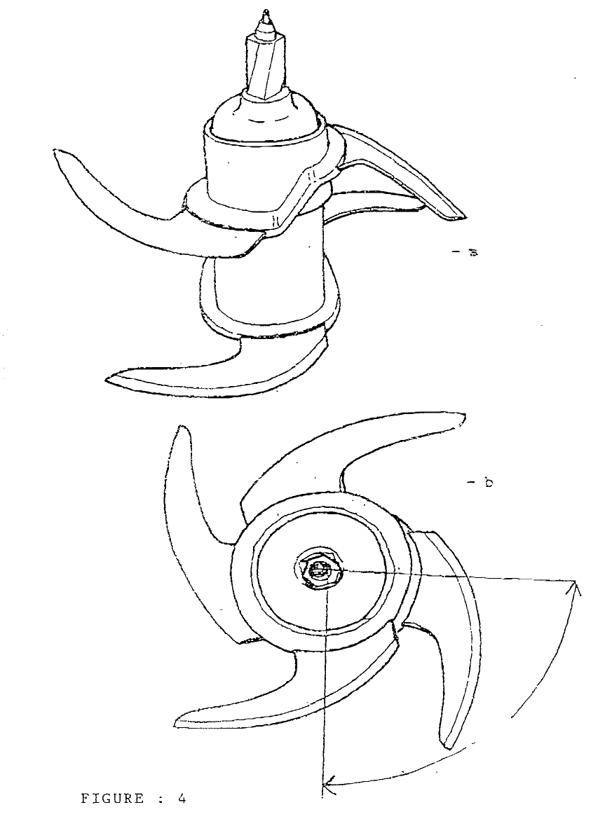

FIG. 5: Use of blades in devices with a lower engine block.

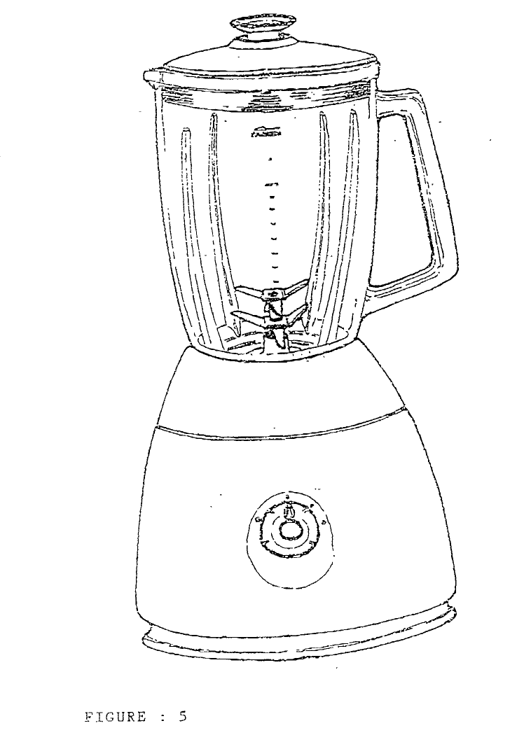

FIG. 6: Front (a), back (a), bottom (c), top (d), right-hand (e) and left-hand (f) profile views of blades with multi-centers and multi-wings as positioned at various angles relative to each other.

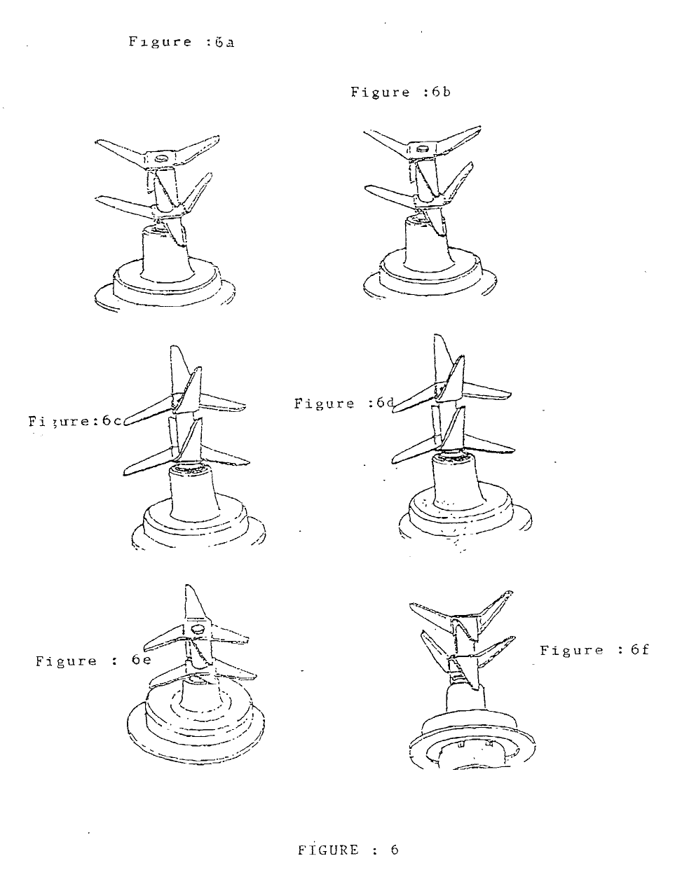

FIG. 7: Use of blades in devices with an upper engine block.

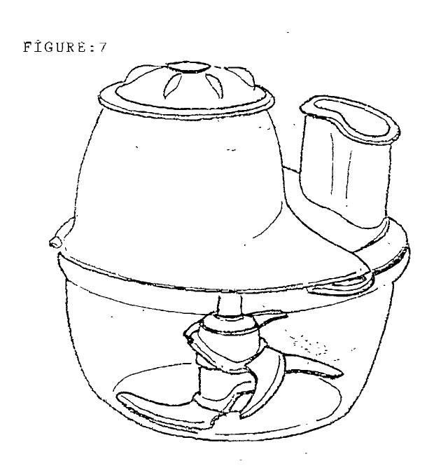

FIG. 8: Position and assembly of blade and other device components in devices with an upper engine block (a, b, c, d, e)

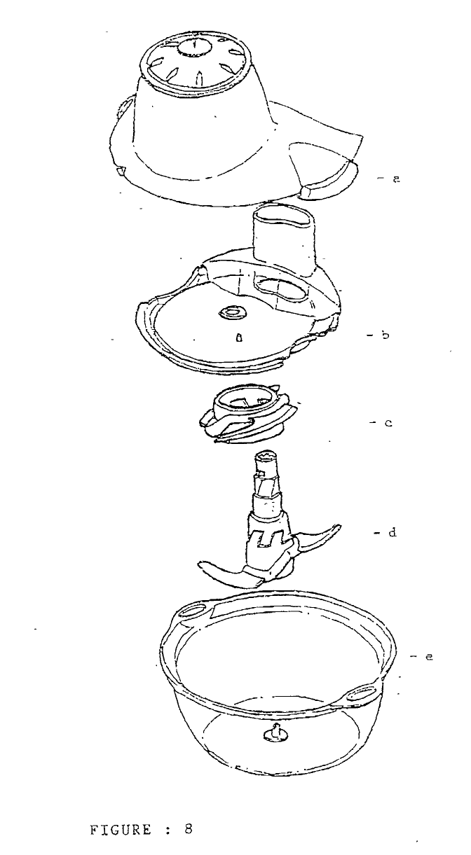

### DETAILED DESCRIPTION OF THE INVENTION

Present invention can also be used with any driven, electric-powered, cutter-parting, stirrer blender, robot and mixer etc. devices either house type or industrial type with a side engine block (1, 2), upper engine block (7, 8) or lower engine block (5).

Present invention can be used with any containers, either with plastic base, made of stainless steel or glass.

Present invention can be used with products of any kind, made of stainless or stained steel, in any thickness and diameter (3), and at positions between 0 and 180 degrees relative to each other (4-b).

With the present invention, it is possible to use a blade with multiple centers and one or more wings selected from the blades with multipoint center and multi-wings having cutter, parter and mixer characteristics, in a device.

With the present invention, it is also possible to position multiple blades at any possible angle (4-b, 6) relative to each other and to lock the multiple blades to middle axis.

I claim:

1. An industrial blade with a multi-point center and multi-wings which can be used with any driven, electric-powered, cutter-parting, stirrer blender, robot and mixer etc. devices either house type or industrial type, positioned at every possible angle with respect to each other and locked to middle axis.

2. An industrial blade according to claim 1 characterized in being used with any driven, electric-powered, cutter-parting, stirrer blender, robot, and mixer etc. devices either house type or industrial type with a side engine block (1, 2), upper engine block (7, 8) lower engine block (5).

3. An industrial blade according to claim 1 characterized in being used with any containers, either with plastic base, made of stainless steel or glass.

4. An industrial blade according to claim 1 characterized in being made of any stainless or stained steel products of any kind, in any thickness and diameter (3), and at positions between 0 and 180 degrees relative to each other (4-b).
